(19) United States
(12) Patent Application Publication
(10) Pub. No.: US 2014/0286004 A1
(43) Pub. Date: Sep. 25, 2014

(54) Lamp Tubes

(71) Applicants: Chia-Ching Su, Singapore (SG); Yuan-Ming Yu, Singapore (SG)

(72) Inventors: Chia-Ching Su, Singapore (SG); Yuan-Ming Yu, Singapore (SG)

(73) Assignee: Justing Technology Pte. Ltd., Singapore (SG)

(21) Appl. No.: 14/232,882

(22) PCT Filed: Jul. 13, 2012
(86) PCT No.: PCT/SG2012/000248

§ 371 Date: Apr. 7, 2014

(30) Foreign Application Priority Data
Jul. 14, 2011 (TW) 100125250
Jul. 14, 2011 (TW) 100213133
Jan. 6, 2012 (TW) 101200372
Jan. 6, 2012 (TW) 101200373
May 2, 2012 (CN) 201210133522.X
May 2, 2012 (CN) 201220193702.2
May 2, 2012 (CN) 201220193742.7
May 2, 2012 (CN) 201220193853.8

(51) Int. Cl. F21K 99/00; F21V 23/06; F21V 29/00

(52) U.S. Cl. CPC F21K 9/17; F21V 29/2206; F21V 23/06
USPC 362/218; 362/221

(57) ABSTRACT

A lamp comprising a lamp tube, the lamp tube having a positioning slot formed on an inner side of the lamp tube for receiving a circuit board; two end covers installable at both ends of the lamp tube; each end cover comprises two electrical terminals for receiving electrical power from a source, and each end cover includes a conductive terminal disposed on an inner side of the end cover and coupled to the electrical terminal; and a circuit board arranged to be positioned in the positioning slot, the circuit board includes two sockets disposed at both ends of the circuit board; wherein in operation the conductive terminal of each end cover is plugged into the respective socket to conduct electric power.

### CROSS-REFERENCE TO RELATED APPLICATIONS

This application claims priority from the following Taiwan and China patent applications:
TW 100213133;
TW 100125250;
TW 101200372;
TW 101200373;
CN 201220193853.8;
CN 201210133522.X;
CN 201220193742.7; and
CN 201220193702.2
   the entire contents of which are incorporated herein by reference.

### FIELD OF THE INVENTION

The present invention relates to lamps. In particular the invention relates (not exclusively) to LED lamps and its components, the invention will be described in this context.

### BACKGROUND ART

The following discussion of the background to the invention is intended to facilitate an understanding of the present invention only. It should be appreciated that the discussion is not an acknowledgement or admission that any of the material referred to was published, known or part of the common general knowledge of the person skilled in the art in any jurisdiction as at the priority date of the invention.

Early fluorescent lamp tubes are typically made of glass. As the fluorescent lamp tubes contain therein a small amount of mercury, one has to be extremely careful when taking or mounting the fluorescent lamp because leakage of the mercury within the lamp will damage the environment and may cause intoxication to a human being in contact therewith. Moreover, although the conventional fluorescent lamp is relatively cheap, it has the drawback that as a waste, there might be mercury pollution, or it may easily be broken due to its glass nature.

More recently, improved fluorescent lamp adopts light-emitting diode (LED) for illumination with a structure identical to the design of the earlier fluorescent lamps so as to adapt to the earlier lamp holders, i.e. retrofitting.

With reference to FIG. 1, a structure of a conventional LED lamp tube generally includes a hollow tube body 11, a light emitting module 12 and two external connecting modules 13. The hollow tube body 11 includes a seat body 110 and a lamp cover 111 covering the seat body. The light emitting module 12 includes a circuit board 120 and a plurality of LEDs 121 combined to the circuit board 120. The circuit board 120 has thereon an electrical circuit electrically connected to the LEDs 121. The electrical circuit has two conducting areas 123 nearby each of two sides of the circuit board 120. The two external connecting modules 13 are combined to two ends of the hollow tube body 11. Each external connecting module includes an end cover 130, a fixing block 131 and two terminals. The end cover 130 utilizes a screw bolt 133 to integrate on the seat body 110. The fixing block 131 is screwed onto the seat body 110 through the screw bolt 133. Each of the two terminals includes an embedding block 136 and a guiding post 137. The embedding block 136 is embedded in the fixing block 131, and has one side that is exposed from a bottom side of the fixing block 131, and is soldered to and in contact with an outer side of the outer circuit board 120. The guiding post 137 extends from an end face of the embedding block 136 and extends from the end cover 130 to the outside.

However, current LED lamp tubes have at least the following drawbacks:
1. Assembly of the external connecting module is complicated, thereby increasing assembly cost.
2. Soldering quality is hard to judge with the naked eye. Therefore, tiny cracks may be generated. In addition, if the level of skill of the soldering personnel is inconsistent, soldering quality is easily affected and electrical contacts will be compromised.
3. The described LED lamp tube of FIG. 1 adopts the conventional lamp holder structure, such that when the. LED lamp tube is inserted into the conventional lamp holder structure, since a 90 degree turn is required to connect to the power source, an illuminating face of the LED lamp tube deviates by 90 degrees such that a side under the LED lamp tube cannot receive illumination.

The present invention seeks to provide a lamp that alleviates the above mentioned drawbacks at least in part.

### SUMMARY OF THE INVENTION

This invention aims at providing a lamp tube comprising a tube body, a circuit board and two end covers, the lamp tube facilitates a user to utilize a simple inserting action to form a reliable electrical conductive contact, whose circuit board and tube body are operable to rotate 360 degrees relative to the end covers to adjust the effects provided at different illuminating angles, thereby enhancing the overall usability.

In accordance with a first aspect of the invention there is a lamp tube, comprising a tube body, an inner side of said tube body being provided with a positioning slot; two end covers respectively disposed at two ends of said tube body, each of said end covers being provided with two electrical terminals, and an inner side of each of said end covers being provided with an electrically conducting terminal, said electrically conducting terminal being connected to said electrical terminals; and a circuit board disposed in said positioning slot, said circuit board being provided at each of two ends with a socket for insertion by said electrically conducting terminal of said end cover operable to form an electrical conduction therewith.

Preferably the tube body is formed at a lower edge thereof with a plurality of heat-dissipating fins.

Preferably said end cover and said tube body are combined through a protruding-rib-and-ring-furrow configuration.

Preferably the electrical terminal and the electrically conducting terminal of the end cover are integrally fabricated. This facilitates ease of moulding and reliable conduction of electricity between the electrical terminal and electrically conducting terminals even when the tube body is rotated relative to the end cover.

Preferably each socket comprises a connecting seat; said connecting seat provided with a housing, said housing comprises at least one inserting slot, said inserting slot being provided therein with a terminal and an electrically conducting plate that is connected to said terminal, said electrically conducting plate extending to a side edge of said housing for electrical connection with said circuit board, said inserting slot being for insertion by said electrically conducting terminal of said end cover to form a conduction therewith.

Preferably the electrically conducting plate extends outwardly from a bottom portion of said housing, said bottom portion of said housing being provided with at least one positioning post, said circuit board being provided with at least one positioning hole for receiving said positioning post.

Preferably the lamp tube comprises a sliding positioning structure disposed between said lamp tube and each of said end covers, said sliding positioning structure being provided with at least one protruding rib and a ring furrow capable of receiving said protruding rib so that said lamp tube and each of said end covers can be secured in position.

Preferably, the protruding rib is provided at an inner surface of each of said end covers, and said ring furrow is provided at an outer surface of said lamp tube proximate to each of two ends thereof. Such an end cover is easy to be moulded.

Alternatively, the protruding rib is provided at an outer surface of said lamp tube proximate to each of two ends, and said ring furrow is provided at en inner surface of each of said end covers.

In accordance with a second aspect of the invention there is an end cover for use with a tube body to form a lamp tube; said end cover being provided with two electrical terminals, and an inner side of each of said end cover being provided with an electrically conducting terminal, said electrically conducting terminal being integrally fabricated with the two electrical terminals; wherein the electrically conducting terminal is arranged to be inserted into a tube body; the tube body comprising a corresponding socket for insertion by the electrically conducting terminal of said end cover to form an electrical conduction therewith.

In accordance with a third aspect of the invention there is a circuit board for disposal within a lamp body comprising a tube body and two end covers, the circuit board being provided at each of two ends with a socket for insertion by an electrically conducting terminal of said end cover to form an electrical conduction therewith.

In accordance with a fourth aspect of the invention there is a socket for use with the circuit board of the third aspect of the invention, the socket comprises a connecting seat; said connecting seat being provided with a housing, said housing comprises at least one inserting slot, said inserting slot being provided therein with a terminal and an electrically conducting plate that is connected to said terminal, said electrically conducting plate extending to a side edge of said housing for electrical connection with said circuit board, said inserting slot being for insertion by said electrically conducting terminal of said end cover to form a conduction therewith.

### BRIEF DESCRIPTION OF THE DRAWINGS

The present invention will now be described, by way of example only, with reference to the accompanying drawing, in which:

FIG. 1 illustrates a schematic representation of a prior art lamp tube;

FIG. 2 illustrates an exploded view of the tube body and the cut-open end cover in accordance with a first embodiment of the invention;

FIG. 3 illustrates a cross-sectional view of the lamp tube in accordance with the first embodiment of the invention;

FIG. 4 illustrates a fitted lamp tube having tube body rotatable with respect to the end cover in accordance with the first embodiment of the invention;

FIG. 5 illustrates an exploded view of the lamp tube with a sliding positioning structure in accordance with a second embodiment of the invention;

FIG. 6 illustrates a cross-sectional view of the lamp tube in accordance with the second embodiment of the invention;

FIG. 7 illustrates a front/end sectional view of the lamp tube in accordance with the second embodiment of the invention;

FIG. 8 illustrates a fitted lamp tube having tube body rotatable with respect to the end cover in accordance with the second embodiment of the invention;

FIG. 9 illustrates the exploded view of the lamp tube in accordance with the second embodiment of the invention with a variant sliding positioning structure;

FIG. 10 illustrates an end view of the lamp tube of FIG. 9;

FIG. 11 illustrates an exploded view of the lamp tube and the cut-open end cover in accordance with a third embodiment of the invention;

FIG. 12 illustrates a cross-sectional view of the lamp tube in accordance with the third embodiment of the invention;

FIG. 13 illustrates a front/end sectional view of the lamp tube in accordance with the third embodiment of the invention; and

FIG. 14 illustrates a fitted lamp tube rotatable with respect to the end cover in accordance with the third embodiment of the invention.

Other arrangements of the invention are possible and, consequently, the accompanying drawings are not to be understood as superseding the generality of the preceding description of the invention.

### PREFERRED EMBODIMENTS OF THE INVENTION

The features of this invention can be clearly understood with reference to the drawings of this case and the detailed description of the embodiments.

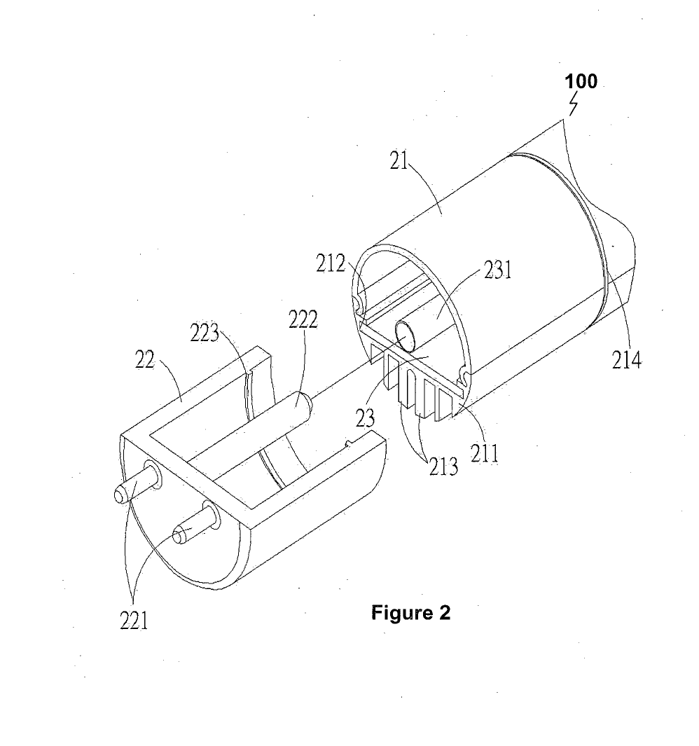

In accordance with a first embodiment of the present invention there is a lamp tube 100. FIG. 2 illustrates the exploded structural diagram of the lamp tube 100. Lamp tube 100 comprises a tube body 21 and two end covers 22 (illustrated as a cut-open section). Lamp tube 100 is adapted to receive a circuit board 23.

At the inner side of the tube body 21 there is provided a seat body 211. The seat body 211 is provided with a positioning slot 212 for placement of the circuit board 23. In the embodiment shown in the FIGS. 2 to 4, the tube body 21 is shaped as a circular tube. The lower edge of the tube body 21 may be formed as a plurality of heat-dissipating fins 213 for heat dissipation. In operation when the circuit board 23 is inserted into the tube body 21 and positioning slot 212, the circuit board 23 is in thermal contact with the heat-dissipating fins 213 for heat-dissipation.

In normal operation, the end covers 22 are respectively disposed at the two ends of the tube body 21. Each end cover 22 is provided with at least two electrical terminals 221 for connection to an electrical source or mains (not shown). At the inner side of each end cover 22, i.e. the side which provides connection to the tube body 21 there is provided an electrical conducting terminal 222.

Electrical conducting terminal 222 comprises conducting material which should withstand a high electrical current (typically up to 2 amperes). Electrical conducting terminal 222 is shaped in a form of a rod. The electrical conducting terminal 222 is electrically connected to the electrical terminals 221, wherein the electrical terminals 221 are integrally fabricated with the electrically conducting terminal 222. The electrical terminals 221 and conducting terminal 222 may be integrally fabricated with the end cover 22 by injection moulding.

Circuit board 23 is disposed within the positioning slot 212. Each end of the circuit board 23 is provided with a socket 231, suitably mounted on the circuit board 23. The circuit board 23 may be provided with a plurality of light-emitting diodes 232. The circuit board 23 has a circuit (not shown) to electrically connect the light-emitting diodes 232. The circuit forms electrical connection with the socket 231. Each socket 231 is adapted to receive a corresponding electrical conducting terminal 222 for the receipt of electrical power. The rod-socket arrangement provides a secure and reliable electrical connection, maximizing the electrical contact in operation where the tube body 21 is rotated relative to the end covers 22. Having a dedicated electrical connector in the form of socket 231 mounted on the circuit board 23 also reduces any direct damage to the main circuit board 23 arising from wear and tear when the end cover 22 is fitted to the circuit board 23 and the tube body 21 is rotated relative to the end covers 22. Any wear and tear is thus restricted to the socket 231 and conducting terminal 222 which may be easily replaceable.

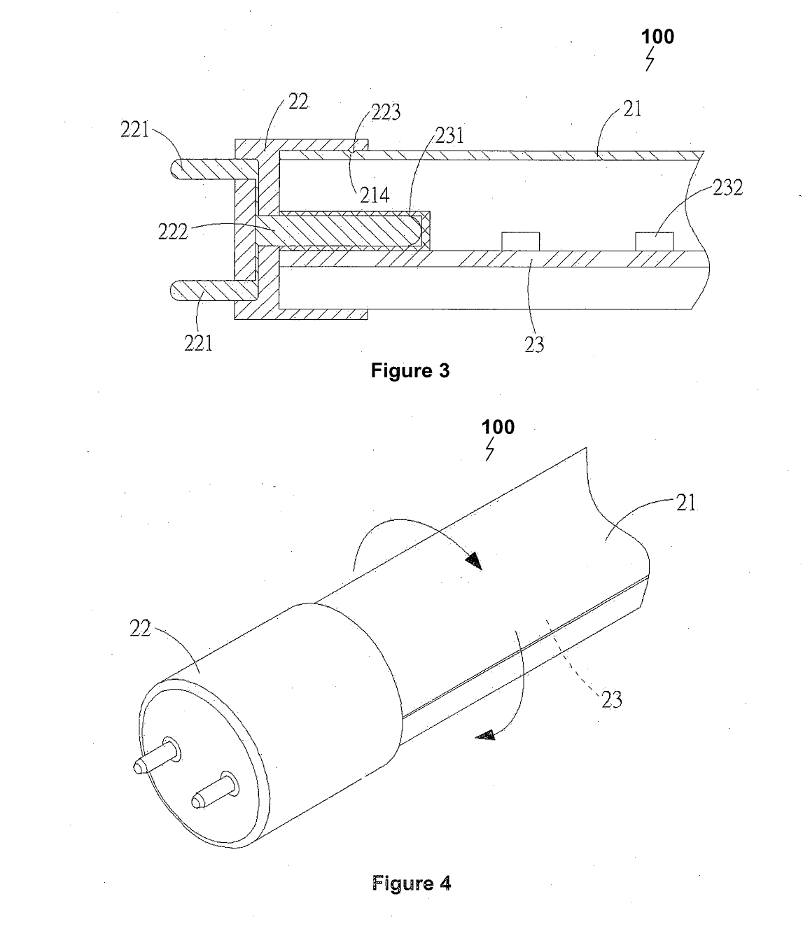

The end cover 22 and the tube body 21 may be connected through a protruding-rib-and-ring-furrow configuration. In the embodiment shown in the FIG. 3, at the inner side of the end cover 22 there is provided a ring of protruding rib 223 and the tube body 21 is correspondingly provided with a ring furrow 214. The circumference and diameter of the end cover 22 are greater than the circumference and diameter of the tube body 21. Through securing the end cover 22 and the tube body 21 through this embedding method, and by directly inserting the electrically conducting terminal 222 of each end cover 22 into the socket 231 to form an electrical contact, when the tube body 21 of this embodiment is inserted into a conventional lamp seat structure, the electrical terminals 221 and the electrically conducting terminal 222 form an electrical current loop through the socket 231 and the circuit board 23, such that the light emitting diodes 232 emit light and are lit up due to receipt of electrical power.

Alternatively, it may be the case where the end cover 22 is provided at the inner side with a ring furrow 214 and the tube body 21 is correspondingly provided with a ring of protruding rib 223.

This invention has the following advantages as compared to a conventional lamp tube:
1. Through, a simple inserting action, the end cover 22 and the tube body 21 can be assembled, making it easy to assemble, easy to maintain, easy to inspect, and easy to replace components, thereby enhancing usability. It can be appreciated that no screw bolts are required for the fitting and securing of the tube body 21 with end covers 22.
2. Through the arrangement of the tube body 21, the circuit board 23 and the end covers 22, a user may utilize a simple inserting action to form a secure electrical contact. The circuit board 23 and the tube body 21 can rotate by 360 degrees relative to the end cover 22 as shown in FIG. 4 to adjust the effects provided at different illuminating angles, thereby enhancing the overall usability.

It is to be appreciated that Lamp tube 2 may be a LED lamp tube, such as (but not limited to) T8 LED lamp tubes.

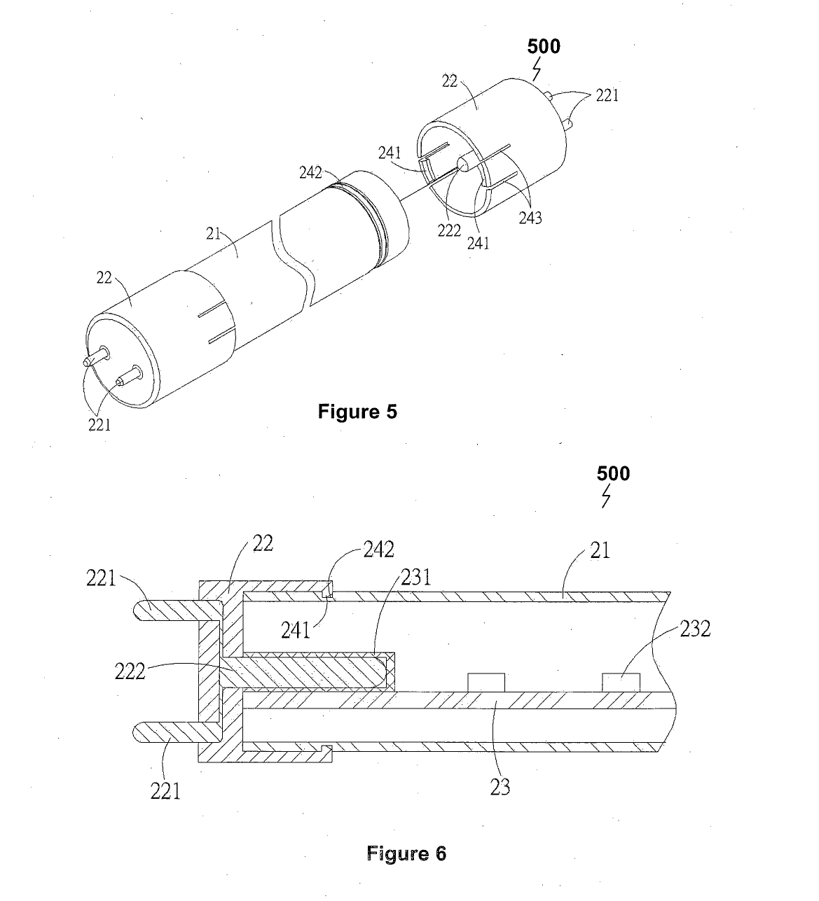

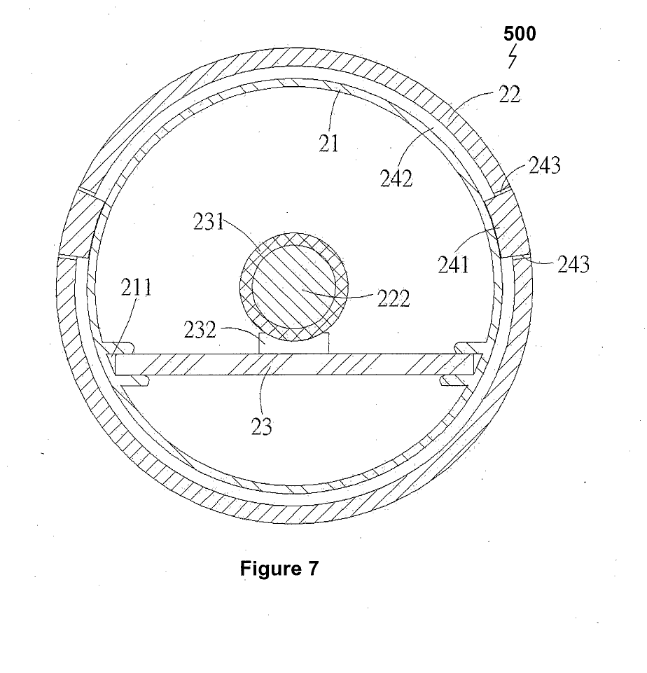

In accordance with a second embodiment of the invention, wherein like numerals reference like parts, there is illustrated in FIG. 5 an exploded structural diagram of a lamp tube 500 of this invention. The side sectional view of the LED lamp tube 500 is illustrated in FIG. 6, and the front/end sectional view of the LED lamp tube 500 is illustrated in FIG. 7. The LED lamp tube 500 comprises a tube body 21, two end covers 22, a circuit board 23 and a sliding positioning structure 240.

At the inner side of the tube body 21 there is provided a positioning slot 211 for placement of the circuit board 23.

In operation, the end covers 22 are respectively disposed at two ends of the tube body 21. Each end cover 22 is provided with two electrical terminals 221, and at the inner side of each end cover 22 there is provided an electrically conducting terminal 222. The electrically conducting terminal 222 is connected to the electrical terminals 221, wherein the electrical terminals 221 are integrally fabricated with the electrically conducting terminal 222, and is integrally fabricated with the end cover 22 by over molding.

In normal operation, the circuit board 23 is disposed within the positioning slot 212. The circuit board 23 is provided at each of two ends with a socket 231 respectively. The circuit board 23 may be provided with a plurality of light-emitting diodes 232. The circuit board 23 has a circuit (not shown) to electrically connect the light-emitting diodes 232. The circuit forms electrical connection with the socket 231.

The sliding positioning structure 240 is disposed between the tube body 21 and each end cover 22 to facilitate a secure connection between the tube body 21 and each end cover 22. The sliding positioning mechanism 240 is provided with at least one protruding rib 241 and a ring furrow 242 for receiving the protruding rib 241. The protruding rib 241 is provided at two sides with a cutting groove 243. In the second embodiment shown in the FIGS. 5 to 7, the protruding rib 241 is disposed at an inner surface of each end cover 22, and the ring furrow 242 is disposed at an outer surface of the tube body 21 proximate to two end sides. Through the cutting grooves 246 providing the protruding rib 241 with elasticity for convenient ‘snap fit’ with the ring furrow 242, and through engagement of the protruding rib 241 and the ring furrow 242, the tube body 21 and the end covers 22 may be secured in position.

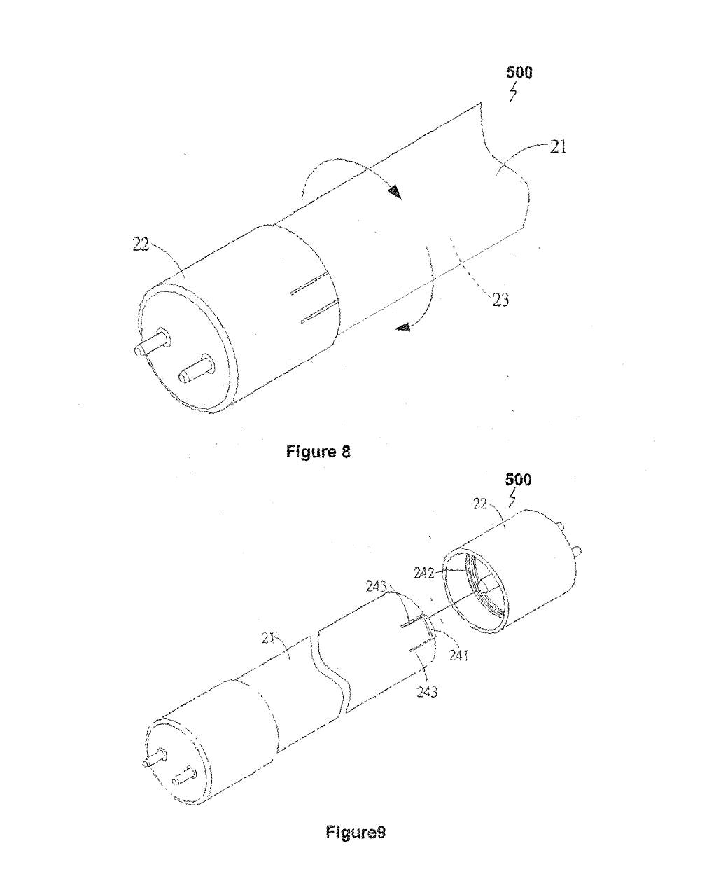

Through directly inserting the electrically conducting terminal 222 of each end cover 22 into the socket 231 to form an electrical contact conduction, when the tube body 21 is inserted into a conventional lamp seat structure, the electrical terminals 221 and the electrically conducting terminal 222 form an electrical current loop through the socket 231 and the circuit board 23, such that the light emitting diodes 232 emit light and are lit up when electrical power is provided from the mains. In addition, through the protruding rib 241 sliding in the ring furrow 242, the tube body 21 and each end cover 22 can perform relative rotations by 360 degrees as shown in FIG. 8 to constitute an orientation turn of the lamp tube and the circuit board, thereby facilitating adjustment to the required illuminating angle during use.

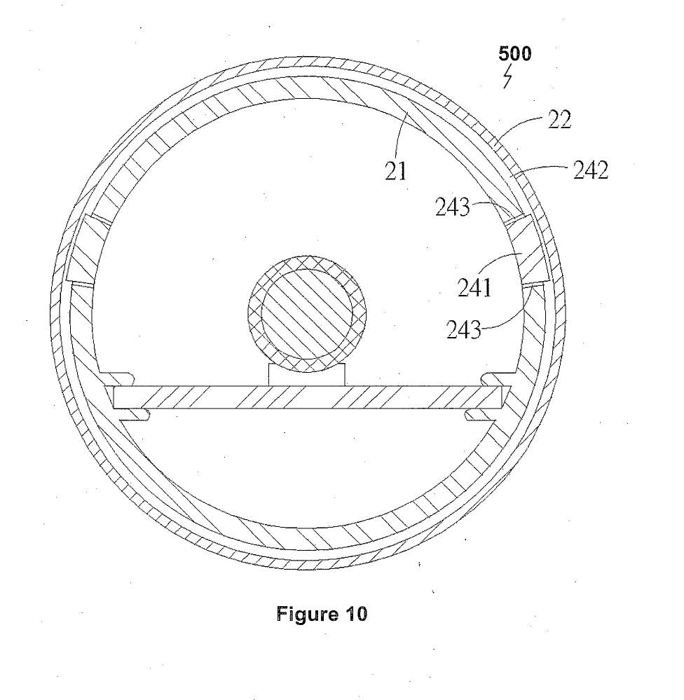

Alternatively, the protruding rib 241 may also be disposed at an outer surface of the tube body 21 proximate to the two end sides as shown in FIG. 9 and FIG. 10, with the ring furrow 242 disposed at the inner surface of each end cover 22, to equally make the tube body 21 and each end cover 22 secure in position and capable of relative rotations.

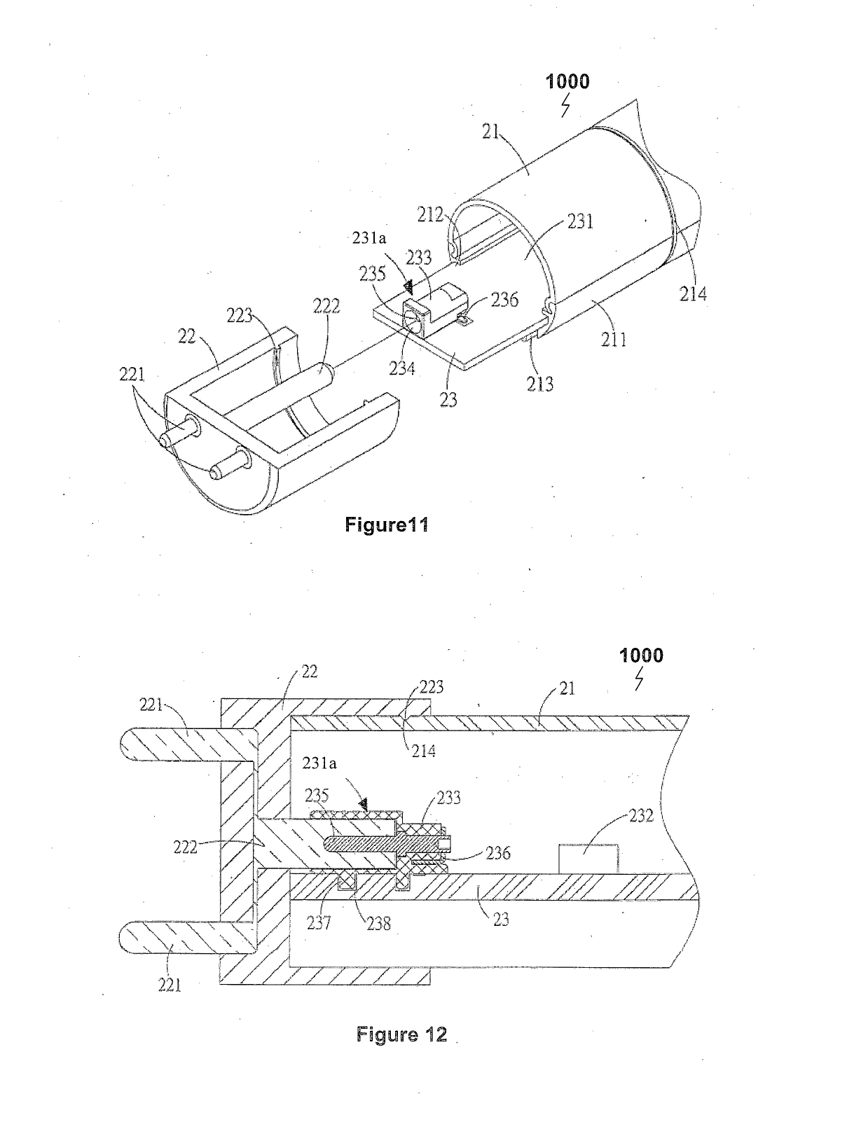

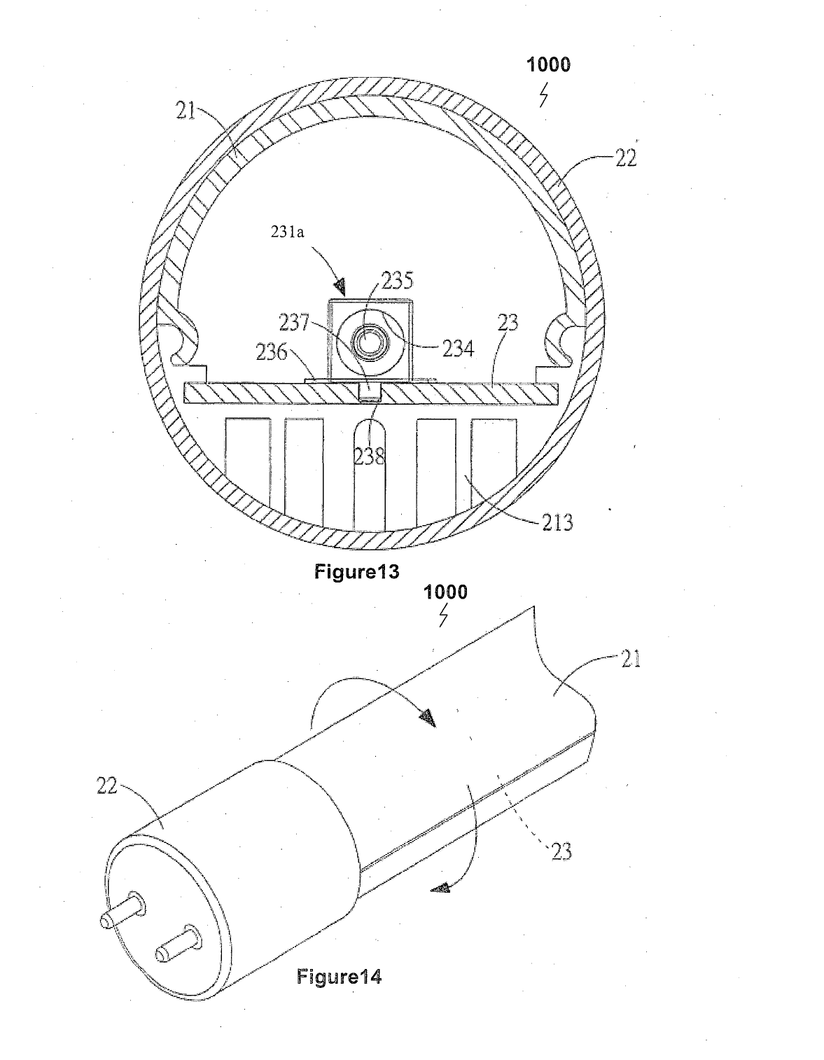

In accordance with the third embodiment of the invention where like numerals reference like parts there is provided a lamp tube 1000, the structural schematic diagram of which is illustrated in FIGS. 11 to 13. The LED lamp tube 1000 includes: a tube body 21 and two end covers 22. Lamp tube 1000 is adapted to receive a circuit board 23.

At the inner side of the tube body 21 there is provided a seat body 211. The seat body 211 is provided with a positioning slot 212 for placement of the circuit board 23. In the embodiment shown in the figure, the lamp tube 21 is circular-tube shaped, and at a lower edge of the tube body 21 there are formed a plurality of heat-dissipating fins 213 for heat dissipation. In normal operation, the end covers 22 are respectively disposed at two ends of the lamp tube 21. Each end cover 22 is provided with two electrical terminals 221, and at the inner side of each end cover 22 there is provided an electrically conducting terminal 222. The electrically conducting terminal 222 is connected to the electrical terminals 221, wherein the electrical terminals 221 are integrally fabricated with the electrically conducting terminal 222, and is integrally fabricated with the end cover 22 by over molding.

In normal operation, the circuit board 23 is disposed within the positioning slot 212. The circuit board 23 is provided at each of two ends with a connecting seat 231a. The circuit board 23 may be provided with a plurality of light-emitting diodes 232. The circuit board 23 has a circuit (not shown) to electrically connect the light-emitting diodes 232. The circuit forms electrical connection with the connecting seat 231a.

The connecting seat 231a comprises a housing 233. Housing 233 is made of an electrical insulative material, for example, reinforced Polybutylene terephthalate (PBT). The reinforced PBT is able to resist heat of up to 300 degree Celsius. The housing 233 is provided with at least one inserting slot 234. The inserting slot 234 is provided inside with an electrical terminal 235 and an electrically conducting plate 236 is connected to the terminal 235 (Refer to FIG. 11 and FIG. 12). The electrically conducting plate 236 extends to the side edge of the housing 233. In the third embodiment shown, the electrically conducting plate 236 extends from the bottom portion of the housing 233 outwardly so as to be soldered to the circuit board 23 to be in electrical connection with the circuit board 23. The inserting slot 234 is provided for insertion of the electrically conducting terminal 222 of the end cover 22 such that the electrically conducting terminal 222 and the terminal 235 are in contact with each other to form an electrical conduction. Moreover, the housing 233 is provided at the bottom portion with at least one positioning post 237. The circuit board 23 is provided with at least one positioning hole 238 for receiving the positioning post so that the connecting seat 231a can be more stably positioned on the circuit board 23.

When the lamp tube 1000 is inserted into a conventional lamp seat structure, the electrical terminals 221 and the electrically conducting terminal 222 form an electrical current loop through the connecting seat 231a and the circuit board 23, such that the light emitting diodes 232 emit light and are lit up due to receipt of electrical power from the mains. Therefore, this embodiment utilizes a simple inserting action to assemble the end cover and the lamp tube, making it easy to assemble, easy to maintain, easy to inspect, and easy to replace components, thereby enhancing usability.

Moreover, the end cover 22 and the lamp tube 1000 may be combined through a protruding-rib-and-ring-furrow configuration as depicted in the second embodiment.

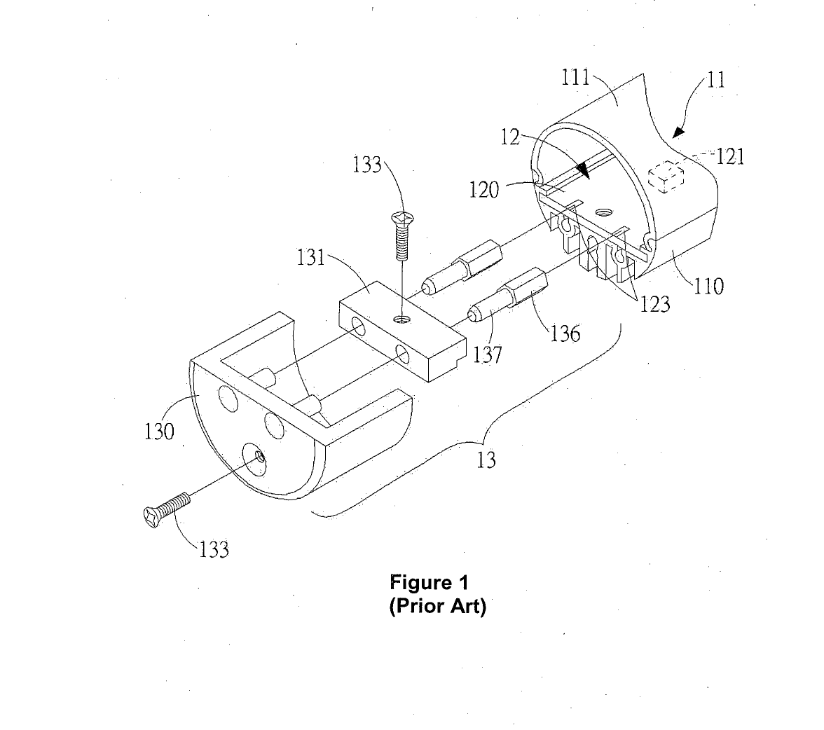

In summary, the embodiments provide a better and practical LED lamp tube which does not require screws bolts as depicted in the prior art shown in FIG. 1. Based on the disclosure of this invention, those skilled in the art may still perform various replacements and modifications that do not depart from the spirit of this invention, in particular, the features of each embodiment may be combined to form further embodiments. Therefore, the protective scope of this invention should not be limited to the disclosure of the embodiments, and should encompass various replacements and modifications that do not depart from this invention and that are covered by the following claims.

1. A lamp tube, comprising:
a tube body, an inner side of said tube body provided with a positioning slot;
two end covers respectively disposed at two ends of said tube body, each of said end covers being provided with two electrical terminals, and an inner side of each of said end covers being provided with a rod shaped electrically conducting terminal, said electrically conducting terminal being connected to said electrical terminals; and
a circuit board disposed in said positioning slot, said circuit board being provided at each of two ends with a socket arranged to receive said rod shaped electrically conducting terminal of said end cover operable to form an electrical conduction therewith, wherein the rod shaped electrically conducting terminal and socket are configured such that the tube body is rotatable relative to the end covers.

2. The lamp tube of claim 1, wherein said tube body is formed at a lower edge thereof with a plurality of heat-dissipating fins.

3. The lamp tube of claim 1, wherein said end cover and said tube body are combined through a protruding-rib-and-ring-furrow configuration.

4. The lamp tube according to claim 1, wherein the two electrical terminals and the electrically conductive terminal of the end cover are integrally fabricated.

5. The lamp tube according to claim 1 wherein each socket comprises a connecting seat; said connecting seat being provided with a housing, said housing comprises at least one inserting slot, said inserting slot being provided therein with a terminal and an electrically conducting plate that is connected to said terminal, said electrically conducting plate extending to a side edge of said housing for electrical connection with said circuit board, said inserting slot being for insertion by said electrically conducting terminal of said end cover to form a conduction therewith.

6. The lamp tube according to claim 5, wherein said electrically conducting plate extends outwardly from a bottom portion of said housing.

7. The lamp tube according to claim 6, wherein said bottom portion of said housing is provided with at least one positioning post, said circuit board being provided with at least one positioning hole for receiving said positioning post.

8. The lamp tube according to claim 1, wherein the lamp tube comprises a sliding positioning structure disposed between said lamp tube and each of said end covers, said sliding positioning structure being provided with at least one protruding rib and a ring furrow capable of receiving said protruding rib so that said lamp tube and each of said end covers can be secured in position.

9. The lamp tube according to claim 8, wherein said protruding rib is provided at an inner surface of each of said end covers, and said ring furrow is provided at an outer surface of said lamp tube proximate to each of two ends thereof.

10. The lamp tube according to claim 8, wherein said protruding rib is provided at an outer surface of said lamp tube proximate to each of two ends, and said ring furrow is provided at en inner surface of each of said end covers.

11. An end cover for use with a tube body to form a lamp tube; said end cover being provided with two electrical terminals, and an inner side of each of said end cover being provided with a rod shaped electrically conducting terminal, said electrically conducting terminal being integrally fabricated with the two electrical terminals;
wherein the rod shaped electrically conducting terminal is arranged to be inserted into a tube body; the tube body comprising a corresponding socket arranged to receive the rod shaped electrically conducting terminal of said end cover to form an electrical conduction therewith, wherein the rod shaped electrically conducting terminal and socket are configured such that the tube body is rotatable relative to the end covers.

12. A circuit board for disposal within a lamp body comprising a tube body and two end covers, the circuit board being provided at each of two ends with a socket arranged to receive a rod shaped electrically conducting terminal of said end cover to form an electrical conduction therewith, wherein the rod shaped electrically conducting terminal and socket are configured such that the tube body is rotatable relative to the end covers.

13. A socket for use with the circuit board according to claim 12, the socket comprises a connecting seat; said connecting seat being provided with a housing, said housing comprises at least one inserting slot, said inserting slot being provided therein with a terminal and an electrically conducting plate that is connected to said terminal, said electrically conducting plate extending to a side edge of said housing for electrical connection with said circuit board, said inserting slot being arranged to receive said rod shaped electrically conducting terminal of said end cover to form a conduction therewith, wherein the rod shaped electrically conducting terminal and socket are configured such that the tube body is rotatable relative to the end covers.

14. The lamp tube of claim 2, wherein said end cover and said tube body are combined through a protruding-rib-and-ring-furrow configuration.
